(19) United States
(12) Patent Application Publication
(10) Pub. No.: US 2026/0085580 A1
(43) Pub. Date: Mar. 26, 2026

(54) LADDER LEVELING DEVICE AND LADDER

(71) Applicant: Qianwen Liu, Xiamen (CN)

(72) Inventor: Qianwen Liu, Xiamen (CN)

(21) Appl. No.: 19/329,620

(22) Filed: Sep. 16, 2025

(30) Foreign Application Priority Data
Sep. 25, 2024 (CN) 202422346474.3

(51) Int. Cl. E06C 7/42; E06C 7/44; E06C 7/46

(52) U.S. Cl. CPC E06C 7/426; E06C 7/44; E06C 7/46

(57) ABSTRACT

A ladder leveling device and a ladder are provided. The ladder leveling device includes a base, a lifting support, and a support plate, where the lifting support includes a support frame, a sliding frame, a rod seat, and a sliding rod. The support frame is arranged on the base; the sliding frame supports the support plate and is slidably mounted on the support frame; the rod seat is fixed in the support frame and has a fulcrum therein; and the sliding rod has one end supporting the support plate and the other end slidably inserted into the rod seat, at least one adjustment plate is provided on the sliding rod, the adjustment plate has one end supported by the fulcrum and the other end being a free end for adjustment, and the free end maintains downward under the action of a limit spring.

### CROSS REFERENCE TO THE RELATED APPLICATIONS

This application is based upon and claims priority to Chinese Patent Application No. 2024223464743, filed on Sep. 25, 2024, the entire contents of which are incorporated herein by reference.

### TECHNICAL FIELD

The present invention relates to the technical field of ladder accessories, in particular to a ladder leveling device and a ladder.

### BACKGROUND

A ladder is a tool used for reaching height in daily life. It consists of two vertical poles and multiple horizontal poles suitable for climbing set between the two vertical poles for aloft work.

To ensure the safety of a ladder in use, the ladder needs to be maintained stable. However, in actual use scenarios, the ladder may need to be used on a step surface. Since the step surface is not a flat ground, generally a block, such as brick or book, will be placed on the lower surface for leveling the ladder. However, it is unstable by doing this way. The block is prone to shifting, causing the ladder to become unbalanced, making it difficult to ensure the safety of the ladder when used on a step surface. Alternatively, the ladder can only be used horizontally along a step, with limitations and lacking flexibly.

In another usage scenario, the outdoor ground may have uneven factors such as rough ground and level difference. When using a ladder on uneven ground, two sides of the ladder are placed at different levels, which may easily cause the ladder to tilt or even fall down, and also lead to sliding of ladder legs during use, increasing instability during use.

### SUMMARY

The present invention aims to provide a ladder leveling device and a ladder, aiming to improve the problem that existing ladders do not have a leveling structure.

To achieve the above objective, the present invention adopts the following technical solution:

A ladder leveling device, including a base, a lifting support, and a support plate, where the lifting support includes:
a support frame, where the support frame is arranged on the base;
a sliding frame, where the sliding frame supports the support plate and is slidably mounted on the support frame;
a rod seat, where the rod seat is fixed in the support frame and has a fulcrum therein; and
a sliding rod, where the sliding rod has one end supporting the support plate and the other end slidably inserted into the rod seat, at least one adjustment plate is provided on the sliding rod, the adjustment plate has one end supported by the fulcrum and the other end being a free end for adjustment, and the free end maintains downward under the action of a limit spring.

Preferably, retaining walls are provided around the support plate.

Preferably, an adapter frame is further included. The adapter frame is arranged above the sliding frame and the sliding rod, and the adapter frame supports the support plate.

A first mounting hole and a second mounting hole are provided on the retaining wall, and a butterfly bolt connected to the first mounting hole and a first connecting member rotatably connected to the second mounting hole are provided on a side wall of the adapter frame.

Preferably, a plurality of first mounting holes are provided, and the plurality of first mounting holes are spaced apart at an equal interval; and/or a plurality of second mounting holes are provided, and the plurality of second mounting holes are spaced apart at an equal interval.

Preferably, a plurality of adjustment plates are provided.

Preferably, a limiting plate is provided at a side of the bottom of the support frame, and a limiting notch is provided on the limiting plate.

A limiting member is rotatably provided on the base for engagement or disengagement with the limiting notch.

A ladder leveling device is further provided, including a base and a lifting support. The lifting support includes:
a support frame, where the support frame is arranged on the base;
a sliding frame, where one end of the sliding frame is provided with a connecting portion, and the sliding frame is slidably mounted on the support frame;
a rod seat, where the rod seat is fixed in the support frame and has a fulcrum therein;
a sliding rod, where the sliding rod has one end arranged on the connecting portion and the other end slidably inserted into the rod seat, at least one adjustment plate is provided on the sliding rod, the adjustment plate has one end supported by the fulcrum and the other end being a free end for adjustment, and the free end maintains downward under the action of a limit spring; and
a connecting member, where the connecting member is used to connect the sliding frame to a ladder.

Preferably, the connecting member is a bolt, screw, or rivet, alternatively, the connecting member is a mounting bracket, the mounting bracket includes an engaging portion that engages with the connecting portion and a fixing portion for connection to the ladder.

Preferably, the base is hingedly mounted on the support frame.

An anti-slip portion is provided on the bottom surface of the base, and the anti-slip portion is integrally formed with the base, alternatively, a hook is provided on the bottom surface of the base, and the anti-slip portion is provided with a notch that engages with the hook.

Preferably, the base is provided with engaging teeth on its sides.

A ladder is further provided, including a ladder body and the ladder leveling device described above.

After adopting the above technical solution, the present invention has the following advantages compared with the prior art:
1. The ladder leveling device of the present invention is suitable for use in a step-like environment. The based is placed on a step surface, and the support plate can be placed on another step surface higher than that where the base is located, followed by performing an adjustment through the lifting support, so that the support plate presents a horizontal state, thereby providing a horizontal surface for the ladder to be placed.
2. The height of the lifting support of the ladder leveling device of the present invention can be adjusted by moving the adjusting plate, thereby achieving the purpose of adjusting the horizontal height of the support plate. The adjustment plate is oblique under the action of its own weight or the limit spring, thereby pulling the sliding rod obliquely to achieve the effect of locking the sliding rod. That is, by releasing the adjustment plate, the sliding rod can be automatically locked to make the lifting support at a fixed height, involving simple operations.
3. In the present invention, the ladder leveling device according to another embodiment is suitable for use in an outdoor environment with rough ground. The ladder leveling device is mounted on the ladder legs at two sides of the ladder. By adjusting the height of the lifting support, the height of the ladder legs is adjusted to maintain the ladder in a horizontal state on uneven ground. This effectively prevents the ladder from tilting or shaking caused by uneven ground during use, thereby improving the ladder's stability.

### BRIEF DESCRIPTION OF THE DRAWINGS

FIG. 1 is a schematic diagram showing the structure of a ladder leveling device according to Embodiment 1 of the present invention from a first perspective;

FIG. 2 is a schematic diagram showing the structure of the ladder leveling device according to Embodiment 1 of the present invention from a second perspective;

FIG. 3 is a cross-sectional view showing the lifting support of the ladder leveling device according to Embodiment 1 of the present invention;

FIG. 4 is a partially enlarged view showing the portion A in FIG. 3;

FIG. 5 is a schematic diagram of the ladder leveling device according to Embodiment 1 of the present invention in a disassembled state;

FIG. 6 is a schematic diagram showing a partial structure of the ladder leveling device according to Embodiment 1 of the present invention.

FIG. 7 is a schematic diagram showing the structure of a ladder leveling device according to Embodiment 2 of the present invention;

FIG. 8 is a schematic diagram showing the ladder leveling device according to Embodiment 2 of the present invention in a disassembled state;

FIG. 9 is a cross-sectional view showing the ladder leveling device according to Embodiment 2 of the present invention;

FIG. 10 is a partially enlarged view showing the portion B in FIG. 9;

FIG. 11 is a schematic diagram showing the base and the anti-slip portion of the ladder leveling device according to Embodiment 2 of the present invention in the disassembled state;

FIG. 12 is a schematic diagram showing the ladder leveling device according to Embodiment 2 of the present invention in another disassembled state;

FIG. 13 is a schematic diagram showing a ladder according to Embodiment 3 of the present invention in cooperation with the ladder leveling device.

### ILLUSTRATION OF THE REFERENCE NUMERALS

1. ladder leveling device
10. base; 101. square pin; 102. second connecting member; 103. anti-slip pad;
104. limiting member; 105. engaging teeth; 106. hook;
11. lifting support; 111. support frame; 1111. adjustment opening; 1112. second strip-shaped opening;
11121. reinforcing plate; 1113. limiting plate; 11131. limiting notch; 1114. anti-slip portion;
11141. notch; 112. sliding frame; 1121. first strip-shaped opening; 1122. connecting portion;
11221. inverted hook portion; 11222. pin; 1123. step-like portion; 113. rod seat;
1131. fulcrum; 114. sliding rod; 1141. adjustment plate; 11411. adjustment gap;
1142. sliding gap; 1143. limit spring; 115. mounting bracket; 1151. notch;
1152. engaging portion; 1153. fixing portion; 116. connecting member;
12. support plate; 121. retaining wall; 1211. first mounting hole; 1212. second mounting hole;
13. adapter frame; 131. butterfly bolt; 132. first connecting member;
2. ladder body.

### DETAILED DESCRIPTION OF THE EMBODIMENTS

To make the purposes, technical solutions, and advantages of the present invention more clearly understood, the present invention is further described in detail below with reference to the accompanying drawings and embodiments. It should be understood that the specific embodiments described herein are only used to explain the present invention and are not intended to limit the present invention.

In addition, it should be noted that the terms “up”, “down”, “left”, “right”, “vertical”, “horizontal”, “inside”, “outside”, etc. are all based on the orientation or position relationship shown in the accompanying drawings, and are only for the convenience of describing the present invention and simplifying the description, rather than indicating or implying that the device or element of the present invention must have a specific orientation, and therefore cannot be understood as a limitation on the present invention.

When an element is described as being “fixed to”, “arranged on”, or “provided on” another element, it can be directly on the another element or indirectly on the another element. When an element is described as being “connected to” another element, it can be directly connected to the another element or indirectly connected to the another element.

Unless otherwise expressly specified or limited, the terms “mounted”, “linked”, and “connected” should be interpreted in a broad sense. For example, they can refer to fixed, detachable, or integral connections; mechanical or electrical connections; direct connection or indirect connection through an intermediate; and internal communication between two components or interaction between two components. Those skilled in the art will understand the specific meanings of these terms in the present invention according to specific circumstances.

### Embodiment 1

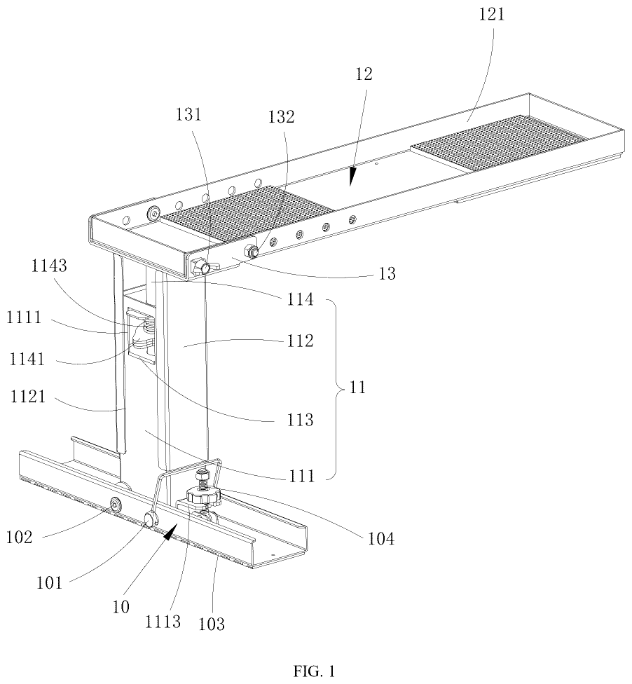

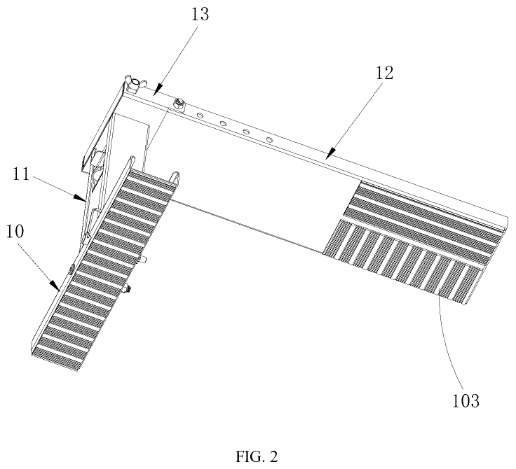

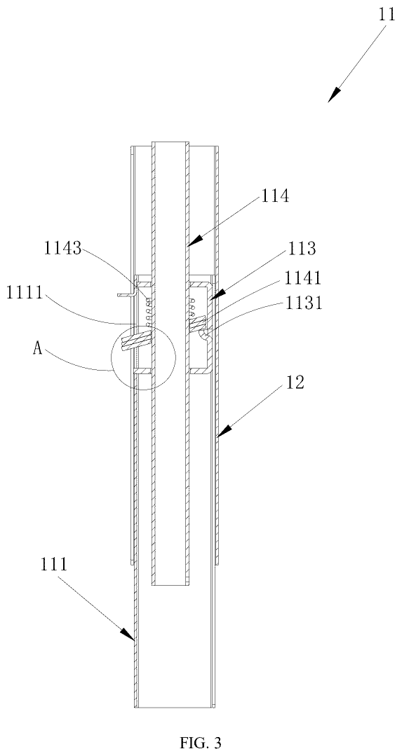

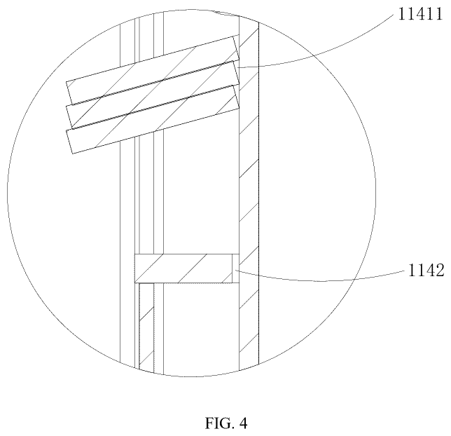

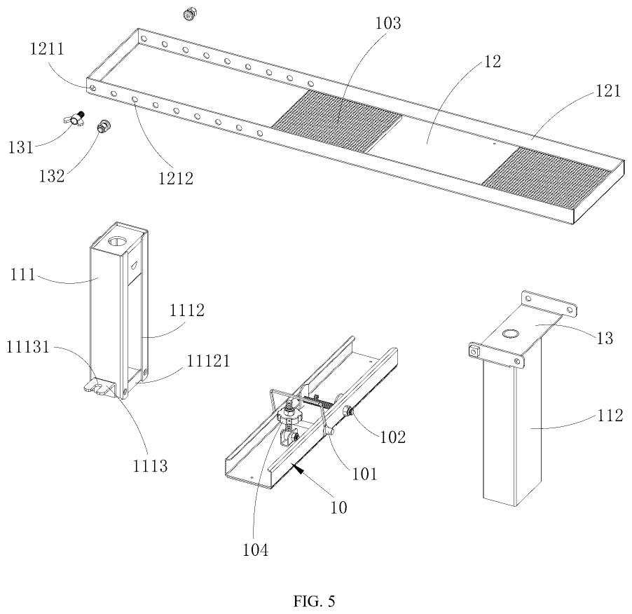

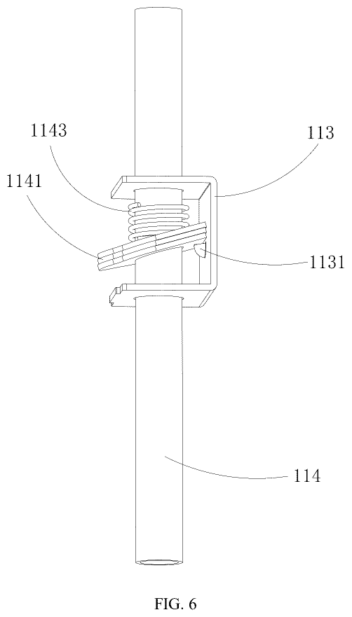

Referring to FIG. 1, FIG. 2, FIG. 3, FIG. 4, FIG. 5, and FIG. 6, the present embodiment provides a ladder leveling device, including a base 10, a lifting support 11, and a support plate 12. The lifting support 11 includes a support frame 111, a sliding frame 112, a rod seat 113, and a sliding rod 114. The support frame 111 is arranged on the base 10; the sliding frame 112 supports the support plate 12 and is slidably mounted on the support frame 111; the rod seat 113 is fixed in the support frame 111 and has a fulcrum 1131 therein; the sliding rod 114 has one end supporting the support plate 12 and the other end slidably inserted into the rod seat 113. At least one adjustment plate 1141 is provided on the sliding rod 114. The adjustment plate 1141 has one end supported by the fulcrum 1131 and the other end being a free end for adjustment, and the free end maintains downward under the action of a limit spring 1143.

Specifically, the ladder leveling device is suitable for use in a step-like environment. The base 10 is placed on a step surface, and the support plate 12 is placed on another step surface higher than that where the base 10 is located, followed by performing an adjustment through the lifting support, so that the support plate 12 presents a horizontal state, thereby providing a horizontal surface for the ladder to be placed.

During use, by moving the adjustment plate 1141, the adjustment plate 1141 rotates with the end that abuts against the fulcrum 1131 as the support point. The fulcrum 1131 can be a hinged end or a protrusion. The circular hole of the adjustment plate 1141 is adjusted toward the horizontal position to form an adjustment gap 11411 with the sliding rod 114 (i.e., the diameter of the circular hole of the adjustment plate 1141 is larger than the diameter of the sliding rod 114, when the adjustment plate 1141 is adjusted toward the horizontal position, the adjustment gap 11411 is formed between the circular hole of the adjustment plate 1141 and the sliding rod 114), allowing the sliding rod 114 to move freely up and down. The diameter of the through hole of the rod seat 113 is larger than the diameter of the sliding rod 114, thus forming a sliding gap 1142 to facilitate the sliding of the sliding rod 114. In this way, by moving the adjustment plate 1141, the horizontal height of the support plate 12 can be adjusted, solving the problem of placing the ladder on stairs and improving the flexibility of use of the ladder.

When in a normal or static state, the adjustment plate 1141 is oblique under the action of its own weight or the limit spring 1143. The oblique adjustment plate 1141 contacts the sliding rod 114 at two points and achieves self-locking under the action of static friction, thereby pulling the sliding rod 114 obliquely to achieve the effect of locking the sliding rod 114. In order to improve the locking force, multiple laminated adjustment plates 1141 can be set for use. In the present embodiment, three adjustment plates 1141 are set (more can be set according to actual needs) to increase the support points with the sliding rod 114 and improve the locking force.

Furthermore, to facilitate the adjustment of the adjustment plate 1141, an adjustment opening 1111 is provided on a side wall of the support frame 111, and the opening of the rod seat 113 is arranged corresponding to the adjustment opening 1111. Since the sliding frame 112 is of a frame structure, a first strip-shaped opening 1121 is provided on a side wall of the sliding frame 112 for avoiding the adjustment opening 1111, and the first strip-shaped opening 1121 is arranged in a way of passing through two ends of the sliding frame 112, so that the adjustment opening 1111 will always be aligned with the first strip-shaped opening 1121, facilitating the adjustment of the adjustment plate 1141 by moving it.

As shown in FIG. 1 and FIG. 5, in the present embodiment, retaining walls 121 are provided around the support plate 12. The arrangement of the retaining walls 121 can form a bounding wall effect on the top surface of the support plate 12, so that the ladder placed on the support plate 12 will not slide away from or fall off the ladder leveling device, thereby improving practicality and safety.

As shown in FIG. 1, FIG. 2, and FIG. 5, the present embodiment further includes an adapter frame 13 arranged above the sliding frame 112 and the sliding rod 114, and the adapter frame 13 supports the support plate 12. A first mounting hole 1211 and a second mounting hole 1212 are provided on the retaining wall 121, and a butterfly bolt 131 connected to the first mounting hole 1211 and a first connecting member 132 rotatably connected to the second mounting hole 1212 are provided on a side wall of the adapter frame 13. The first connecting member 132 can be a bolt-nut structure or a pin structure, etc.

Specifically, the butterfly bolt 131 can be manually disassembled. By removing the butterfly bolt 131 from the first mounting hole 1211, the support plate 12 can rotate relative to the lifting support 11, that is, the support plate 12 rotates around the first connecting member 132 on the second mounting hole 1212, thereby achieving the effect of rotating and folding for storage, so as to facilitate storage and placement and improve practicality.

Further, in the present embodiment, a plurality of first mounting holes 1211 are provided, and the plurality of first mounting holes 1211 are spaced apart at an equal interval; and/or a plurality of second mounting holes 1212 are provided, and the plurality of second mounting holes 1212 are spaced apart at an equal interval. This allows for adjustment of the spacing between the lifting support 11 and a laying end of the support plate 12 (the laying end is the end being placed/laid on the higher step surface of stairs, while the other end of the support plate 12 is connected to the lifting support 11), thereby adapting to stairs with different step widths and improving practicality.

Preferably, the spacing between the first mounting hole 1211 and the second mounting hole 1212 as well as the spacing between two adjacent first mounting holes 1211 or two adjacent second mounting holes 1212 are set to be the same. In this way, only one row of equally spaced mounting holes needs to be set, which reduces the complexity of the structure and improves the production efficiency.

As shown in FIG. 1 and FIG. 5, in the present embodiment, the base 10 is of a frame structure. A side wall of the base 10 is provided with a square pin 101 connected to the bottom of the support frame 111 and a second connecting member 102 rotatably connected to the support frame 111. The second connecting member 102 can be a bolt-nut structure or a pin structure.

In this way, the square pin 101 can be manually removed, so that the base 10 can be rotated and folded toward the support frame 111 with the second connecting member 102 as a rotation axis, facilitating storage. In cooperation with the first connecting member 132 having the effect of rotating and folding for storage, the folding storage effect is achieved, which greatly reduces the storage space and is convenient to use.

As shown in FIG. 1, FIG. 2, and FIG. 5, in the present embodiment, anti-slip pad(s) 103 is/are provided on the bottom surface of the base 10 and/or the top surface of the support plate 12 and/or the bottom surface of the support plate 12. The anti-slip pad(s) 103 can be rubber pad(s) or silicone pad(s). The anti-slip pad 103 provided on the bottom surface of the base 10 and the anti-slip pad 103 provided on the bottom surface of the support plate 12 can increase the friction between the ladder leveling device and a step surface, thereby improving the safety and practicality of the ladder leveling device; and the anti-slip pad 103 provided on the top surface of the support plate 12 can increase the friction between the ladder and the support plate 12, so that the ladder can be placed more stably on the support plate 12.

As shown in FIG. 5, in the present embodiment, a reinforcing plate 11121 is provided at the bottom of the support frame 111; the square pin 101 and the second connecting member 102 are provided in a way of passing through the reinforcing plate 11121. Since the support frame 111 is of a frame structure, a second strip-shaped opening 1112 is provided on a side wall of the support frame 111 and passes through two ends of the support frame 111. The reinforcing plate 11121 is provided at the bottom of the second strip-shaped opening 1112. The reinforcing plate 11121 can be a rectangular plate. The provision of the reinforcing plate 11121 can improve the structural strength of the support frame 111 and meanwhile enhance the locking force between the square pin 101 and the first connecting member 132, thereby providing excellent practicality.

As shown in FIG. 1 and FIG. 5, in the present embodiment, a limiting plate 1113 is provided at a side of the bottom of the support frame 111, and a limiting notch 11131 is provided on the limiting plate 1113; a limiting member 104 is rotatably provided on the base 10 for engagement or disengagement with the limiting notch 11131.

Specifically, the limiting member 104 is rotated to engage with the limiting notch 11131 of the limiting plate 1113, thereby abutting against one side of the support frame 111, eliminating the problem of shaking caused by slight gaps between various connecting joints, and increasing the stability of use of the ladder leveling device.

### Embodiment 2

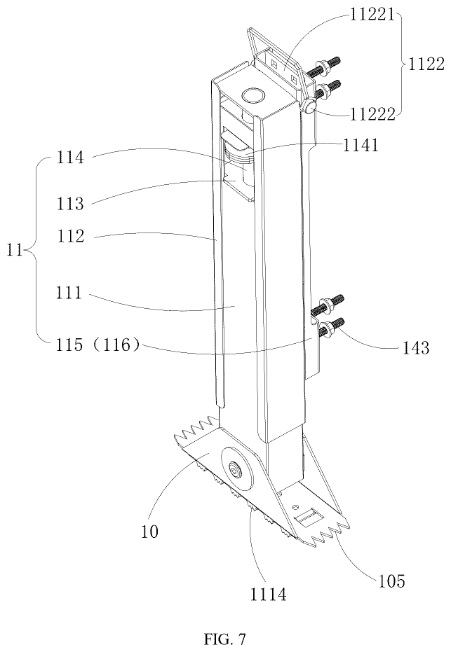

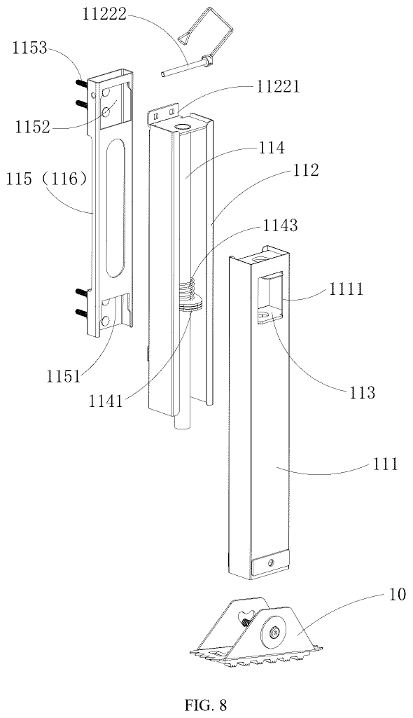

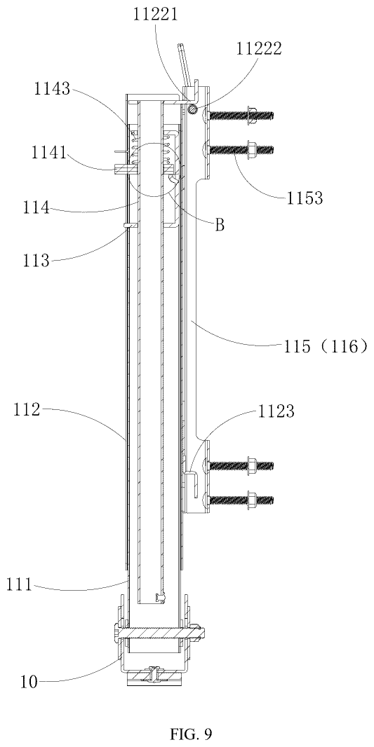

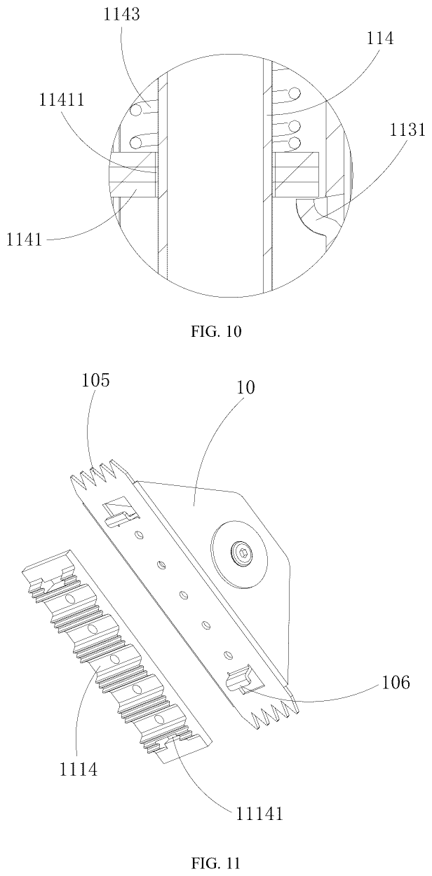

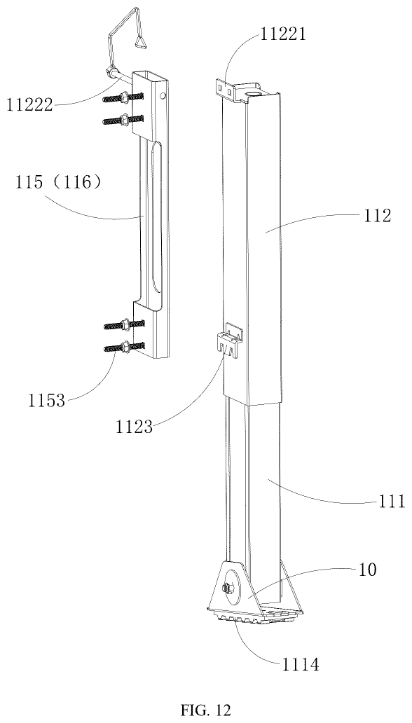

As shown in FIG. 7, FIG. 8, FIG. 9, FIG. 10, FIG. 11, and FIG. 12, the present embodiment provides a ladder leveling device, including a base 10 and a lifting support 11. The lifting support 11 includes a support frame 111, a sliding frame 112, a rod seat 113, a sliding rod 114, and a connecting member 116. The support frame 111 is arranged on the base 10; one end of the sliding frame 112 is provided with a connecting portion 1122, and the sliding frame 112 is slidably mounted on the support frame 111; the rod seat 113 is fixed in the support frame 111 and has a fulcrum 1131 therein; the sliding rod 114 has one end arranged on the connecting portion 1122 and the other end slidably inserted into the rod seat 113. At least one adjustment plate 1141 is provided on the sliding rod 114. The adjustment plate 1141 has one end supported by the fulcrum 1131 and the other end being a free end for adjustment, and the free end maintains downward under the action of a limit spring 1143. The connecting member 116 is used to connect the sliding frame 112 to a ladder.

Specifically, the connecting member 116 is a bolt, screw, or rivet, alternatively, the connecting member 116 is a mounting bracket 115, the mounting bracket 115 includes an engaging portion 1152 that engages with the connecting portion 1122 and a fixing portion 1153 for connection to the ladder. The mounting bracket 115 is connected to a ladder leg through the fixing portion 1153. The mounting bracket 115 and the ladder leg can be welded together, or mounting holes can be reserved in the ladder leg for fixation through bolts or pins, thereby firmly securing the ladder leveling device to the ladder leg. The adjustment plate 1141 is provided with a circular hole for sleeving on the sliding rod 114, and the diameter of the circular hole is larger than that of the sliding rod 114.

During use, the ladder legs at two sides of the ladder are installed with the ladder leveling device, respectively. The free end of the adjustment plate 1141 is lifted, such that the adjustment plate 1141 rotates with the end supported by the fulcrum 1131 as the support point. The circular hole is adjusted toward the horizontal position to form an adjustment gap 11411 (as shown in FIG. 10) with the sliding rod 114, allowing the sliding rod 114 to move freely up and down to drive the sliding frame 112 to extend and retract for adjustment. The extending and retracting movement of the sliding frame 112 facilitates the adjustment of the height of the ladder legs at two sides. When the ladder is adjusted to the horizontal position, the adjustment plate 1141 is released. Under the action of its own weight and the limit spring 1143, the adjustment plate 1141 obliquely slides onto the sliding rod 114. At this time, the circular hole contacts the sliding rod 114 at two points and achieves self-locking under the action of static friction, thereby locking the sliding frame 112, maintaining the ladder in a horizontal state, enhancing stability of the ladder during use, effectively preventing the ladder from tilting or shaking caused by uneven ground during use, ensuring safety of use in rough ground.

As shown in FIG. 8 and FIG. 9, in the present embodiment, the engaging portion 1152 is an L-shaped notch. The connecting portion 1122 includes an inverted hook portion 11221 that engages with the L-shaped notch and a pin 11222 that secures the inverted hook portion 11221 to the L-shaped notch.

Specifically, an opening is formed in the mounting bracket 115 and communicated with the top surface of the mounting bracket 115, thus forming the L-shaped notch structure. After extending the inverted hook portion 11221 through the opening to a position that mates with the L-shaped notch, the pin 11222 is inserted to firmly secure the inverted hook portion 11221 between the L-shaped notch and the pin 11222. This ensures a stable and reliable connection between the sliding frame 112 and the mounting bracket 115. As the sliding frame 112 slides along the support frame 111 for adjustment, the mounting bracket 115 is driven to move, such that the height of the ladder leg is adjusted accordingly.

As shown in FIG. 8 and FIG. 9, in the present embodiment, the mounting bracket 115 has a notch 1151 at its bottom. The sliding frame 112 is provided with a step-like portion 1123, and the step surface of the step-like portion 1123 abuts against the top edge of the notch 1151. Due to the arrangement that the step-like portion 1123 abuts against the top edge of the notch 1151, the step surface of the step-like portion 1123 provides stable support for the mounting bracket 115 during extension and retraction of the lifting support 11, ensuring smooth lifting and lowering of the mounting bracket 115. The top of the mounting bracket 115 cooperates with the connecting member through the engaging portion 1152 to form a first support point, while the bottom of the mounting bracket 115 cooperates with the step-like portion 1123 through the notch 1151 to form a second support point. These upper and lower support points work together to ensure the ladder leveling device remains stable during adjustment.

As shown in FIG. 11, in the present embodiment, the base 10 is hingedly mounted on the support frame 111. An anti-slip portion 1114 is provided on the bottom surface of the base 10, and the anti-slip portion 1114 is integrally formed with the base 10, alternatively, a hook 106 is provided on the bottom surface of the base 10, and the anti-slip portion 1114 is provided with a notch 11141 that engages with the hook 106.

Specifically, when used on relatively smooth ground, the base 10 can be rotated to make the anti-slip portion 1114 contact the ground. The rubber or silicone anti-slip portion 1114 can effectively increase friction with the ground, preventing the ladder from slipping during use. The anti-slip portion 1114 and the base 10 can be fixedly connected, or can be detachably connected through the cooperation of the hook 106 and the notch 11141, facilitating subsequent removal and replacement of the anti-slip portion 1114.

As shown in FIG. 11, in the present embodiment, the base 10 is provided with engaging teeth 105 on its sides. When used outdoors where the ground is uneven, the base 10 can be rotated to allow the engaging teeth 105 on the sides to penetrate into the ground, increasing the ladder's stability. As such, the base 10 can be rotated to switch either the anti-slip portion 1114 or the engaging teeth 105 to contact the ground to adapt to varying ground conditions.

### Embodiment 3

The present embodiment provides a ladder, including a ladder body 2 and a ladder leveling device 1.

Specifically, the ladder leveling device may be the ladder leveling device described in Embodiment 1, suitable for use in a step-like environment. The base 10 of the ladder leveling device is placed on a step surface, and the support plate 12 is placed on another step surface higher than that where the base 10 is located, followed by performing an adjustment through the lifting support 11, so that the support plate 12 presents a horizontal state, thereby providing a horizontal surface for the ladder to be placed, resolving the issue that ladders are unable to be used in a step-like environment.

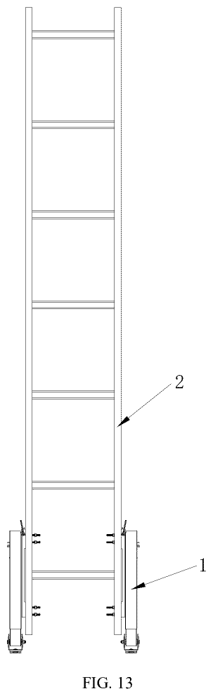

As shown in FIG. 13, in another embodiment, the ladder leveling device 1 may be the ladder leveling device described in Embodiment 2, suitable for use in an outdoor environment with rough ground. The ladder leveling device 1 is mounted on the ladder legs at two sides of the ladder. By adjusting the height of the lifting support 11, the height of the ladder legs is adjusted to maintain the ladder in a horizontal state on uneven ground. This effectively prevents the ladder from tilting or shaking caused by uneven ground during use, thereby improving the ladder's stability.

The above description is merely a preferred embodiment of the present invention, but the scope of protection of the present invention is not limited thereto. Any changes or substitutions that can be easily conceived by a person skilled in the art within the technical scope disclosed in the present invention should be included in the scope of protection of the present invention. Therefore, the scope of protection of the present invention should be determined by the scope of protection of the claims.

What is claimed is:

1. A ladder leveling device, comprising a base, a lifting support, and a support plate, wherein the lifting support comprises:
a support frame, wherein the support frame is arranged on the base;
a sliding frame, wherein the sliding frame supports the support plate and is slidably mounted on the support frame;
a rod seat, wherein the rod seat is fixed in the support frame and has a fulcrum therein; and
a sliding rod, wherein the sliding rod has one end supporting the support plate and the other end slidably inserted into the rod seat, at least one adjustment plate is provided on the sliding rod, the adjustment plate has one end supported by the fulcrum and the other end being a free end for adjustment, and the free end maintains downward under the action of a limit spring.

2. The ladder leveling device according to claim 1, wherein retaining walls are provided around the support plate.

3. The ladder leveling device according to claim 2, further comprising an adapter frame, wherein the adapter frame is arranged above the sliding frame and the sliding rod, and the adapter frame supports the support plate;
a first mounting hole and a second mounting hole are provided on the retaining wall, and a butterfly bolt connected to the first mounting hole and a first connecting member rotatably connected to the second mounting hole are provided on a side wall of the adapter frame.

4. The ladder leveling device according to claim 3, wherein a plurality of first mounting holes are provided, and the plurality of first mounting holes are spaced apart at an equal interval; and/or a plurality of second mounting holes are provided, and the plurality of second mounting holes are spaced apart at an equal interval.

5. The ladder leveling device according to claim 1, wherein a plurality of adjustment plates are provided.

6. The ladder leveling device according to claim 1, wherein a limiting plate is provided at a side of the bottom of the support frame, and a limiting notch is provided on the limiting plate;
a limiting member is rotatably provided on the base for engagement or disengagement with the limiting notch.

7. A ladder leveling device, comprising a base and a lifting support, wherein the lifting support comprises:
a support frame, wherein the support frame is arranged on the base;
a sliding frame, wherein one end of the sliding frame is provided with a connecting portion, and the sliding frame is slidably mounted on the support frame;
a rod seat, wherein the rod seat is fixed in the support frame and has a fulcrum therein;
a sliding rod, wherein the sliding rod has one end arranged on the connecting portion and the other end slidably inserted into the rod seat, at least one adjustment plate is provided on the sliding rod, the adjustment plate has one end supported by the fulcrum and the other end being a free end for adjustment, and the free end maintains downward under the action of a limit spring; and
a connecting member, wherein the connecting member is used to connect the sliding frame to a ladder.

8. The ladder leveling device according to claim 7, wherein the connecting member is a bolt, screw, or rivet, alternatively, the connecting member is a mounting bracket, and the mounting bracket comprises an engaging portion that engages with the connecting portion and a fixing portion for connection to the ladder.

9. The ladder leveling device according to claim 7, wherein the base is hingedly mounted on the support frame;
an anti-slip portion is provided on a bottom surface of the base, the anti-slip portion is integrally formed with the base, alternatively, a hook is provided on the bottom surface of the base, and the anti-slip portion is provided with a notch that engages with the hook.

10. The ladder leveling device according to claim 7, wherein sides of the base are provided with engaging teeth.

11. A ladder, comprising a ladder body and the ladder leveling device according to claim 1.
